(19) United States
(12) Patent Application Publication
(10) Pub. No.: US 2021/0198769 A1
(43) Pub. Date: Jul. 1, 2021

(54) SILVER RECOVERY

(71) Applicant: Greene Lyon Group, Inc., Beverly, MA (US)

(72) Inventors: Svitlana Moskovchenko, Montreal (CA); Andre Brosseau, Montreal (CA)

(73) Assignee: Greene Lyon Group, Inc., Beverly, MA (US)

(21) Appl. No.: 16/769,546

(22) PCT Filed: Dec. 4, 2018
(86) PCT No.: PCT/US2018/063833

§ 371 Date: Jun. 3, 2020

Related U.S. Application Data
(60) Provisional application No. 62/594,255, filed on Dec. 4, 2017.

(51) Int. Cl. C22B 3/00; B22F 9/24

(52) U.S. Cl. CPC C22B 11/04; B22F 2301/255; B22F 9/24

(57) ABSTRACT

Systems and methods for the recovery of silver are generally described. Certain embodiments are related to innovations newly developed within the context of the present invention that exploit the ability of elemental silver (i.e., silver metal in an uncharged, unreacted state—and in certain cases, in relatively high purities) to be recovered from liquids (e.g., suspensions and/or solutions) containing non-elemental silver (i.e., silver ions, silver salts, silver complexes, silver compounds, etc.), by exposing the non-elemental silver to certain reducing agents.

### RELATED APPLICATIONS

This application claims priority under 35 U.S.C. § 119(e) to U.S. Provisional Application No. 62/594,255, filed Dec. 4, 2017, and entitled “Silver Recovery,” which is incorporated herein by reference in its entirety for all purposes.

### TECHNICAL FIELD

Systems and methods for the recovery of silver are generally described.

### SUMMARY

Systems and methods for the recovery of silver are generally described. The subject matter of the present invention involves, in some cases, interrelated products, alternative solutions to a particular problem, and/or a plurality of different uses of one or more systems and/or articles.

In one aspect, a method of producing elemental silver from a silver-containing solution and/or suspension that contains solids comprising non-elemental silver is provided. In some embodiments, the method comprises combining the silver-containing solution and/or suspension with a reducing agent such that at least a portion of the solids comprising the non-elemental silver are exposed to the reducing agent to convert at least a portion of the non-elemental silver from the solids to elemental silver.

In another aspect, a method of producing elemental silver from a silver-containing solution and/or suspension is provided. In some embodiments, the method comprises combining the silver-containing solution and/or suspension comprising silver in non-elemental form with a reducing agent, such that the reducing agent contacts the silver in non-elemental form, and the silver in non-elemental form is reduced to elemental silver.

Other advantages and novel features of the present invention will become apparent from the following detailed description of various non-limiting embodiments of the invention. In cases where the present specification and a document incorporated by reference include conflicting and/or inconsistent disclosure, the present specification shall control.

### DETAILED DESCRIPTION

Certain embodiments are related to innovations newly developed within the context of the present invention that exploit the ability of elemental silver (i.e., silver metal in an uncharged, unreacted state—and in certain cases, in relatively high purities) to be recovered from liquids (e.g., suspensions and/or solutions) containing non-elemental silver (i.e., silver ions, silver salts, silver complexes, silver compounds, etc.), by exposing the non-elemental silver to certain reducing agents. According to some embodiments, the recovered elemental silver can have a relatively high purity (e.g., at least 95 wt %, at least 99 wt %, at least 99.9 wt %, at least 99.99 wt %, at least 99.999 wt %, or higher). In some embodiments, the elemental silver can be recovered by exposing solids comprising non-elemental silver (as opposed to a liquid containing non-elemental silver in the form of silver ions and/or silver-containing complexes in solubilized form) to certain reducing agents. For example, according to some embodiments, elemental silver can be recovered by exposing a reducing agent to solids (for example, suspended within a liquid) comprising silver atoms that are covalently or ionically bonded to at least one non-silver atom (e.g., in a silver-containing salt, an oxide of silver, and/or a nitride of silver).

Certain of the systems and methods described herein can be used to recover elemental silver from a variety of solutions and/or suspensions that contain non-elemental silver. In some embodiments, the silver-containing suspension and/or solution from which the elemental silver is recovered comprises or is derived from any of the leaching solutions described in International Patent Publication No. WO 2015/095664, published on Jun. 25, 2015, and entitled “Method and Apparatus for Recovery of Noble Metals, Including Recovery of Noble Metals from Plated and/or Filled Scrap”; International Patent Publication No. WO 2015/130965, published on Sep. 3, 2015, and entitled “Recovery of Gold and/or Silver from Scrap”; and/or International Patent Publication No. WO 2016/210051, published on Dec. 29, 2016, and entitled “Selective Removal of Noble Metals Using Acidic Fluids, Including Fluids Containing Nitrate Ions”, each of which is incorporated herein by reference in its entirety for all purposes.

In some embodiments, the silver-containing solutions and/or suspensions from which the elemental silver is recovered comprise a mixture of nitric acid and sulfuric acid. In some such embodiments, the silver-containing solutions and/or suspensions from which the elemental silver is recovered includes at least one additional acid, such as, e.g., a sulfonic acid (e.g., methane sulfonic acid) and/or sulfamic acid.

The concentration of the non-elemental silver in the silver-containing solution and/or suspension from which elemental silver is recovered can be at least 1 gram, at least 5 grams, at least 10 grams, at least 25 grams, at least 40 grams, at least 75 grams, at least 100 grams, at least 125 grams, at least 150 grams, or at least 170 grams (and/or, in some embodiments as high as 190 grams, or more) of non-elemental silver per 1 L of the silver-containing solution and/or suspension at 20° C. (When determining the concentration of non-elemental silver per volume of a silver-containing solution and/or suspension, only the mass of the silver atoms is considered, and any mass of counter ions or other elements to which the non-elemental silver is bonded are not counted as part of the concentration determination.) In some embodiments, the silver-containing solution and/or suspension can be both a solution and a suspension, for example, containing solubilized non-elemental silver (e.g., in an amount of at least 1 gram, at least 5 grams, at least 10 grams, at least 25 grams, or at least 40 grams, and/or, in some embodiments as high as 45 grams, or more per 1 L of the silver-containing solution/suspension at 20° C.), as well as additional non-solubilized, suspended silver (e.g., in an amount of at least 1 gram, at least 5 grams, at least 10 grams, at least 25 grams, at least 40 grams, at least 60 grams, at least 80 grams, at least 100 grams, at least 120 grams, or at least 130 grams, or more, per 1 L of the silver-containing solution/suspension at 20° C.). In some embodiments, the concentration of the non-elemental silver in non-solubilized, suspended form within the silver-containing suspension (which may or may not also be a solution containing solubilized silver) can be at least 1 gram, at least 5 grams, at least 10 grams, at least 25 grams, at least 40 grams, at least 75 grams, at least 100 grams, at least 125 grams, at least 150 grams, or at least 170 grams (and/or, in some embodiments as high as 190 grams, or more) of non-solubilized, suspended non-elemental silver per 1 L of the silver-containing suspension at 20° C.

In certain embodiments in which the silver-containing solution and/or suspension contains a strong acid (e.g., nitric acid and/or sulfuric acid), water (e.g., deionized water) may be added to the silver-containing solution and/or suspension until the ratio of the mass of water in the silver-containing solution and/or suspension to the mass of the combination of all acids in the silver containing solution and/or suspension is at least 2:1, at least 3:1, at least 5:1, at least 10:1, at least 50:1, or at least 100:1. In certain embodiments, water (e.g., deionized water) may be added to the silver-containing solution and/or suspension until the ratio of the mass of water in the silver-containing solution and/or suspension to the mass of nitric acid in the silver-containing solution and/or suspension is at least 2:1, at least 3:1, at least 5:1, at least 10:1, at least 50:1, or at least 100:1. In some embodiments, water (e.g., deionized water) may be added to the silver-containing solution and/or suspension until the ratio of the mass of water in the silver-containing solution and/or suspension to the mass of sulfuric acid in the silver-containing solution and/or suspension is at least 2:1, at least 3:1, at least 5:1, at least 10:1, at least 50:1, or at least 100:1. In certain embodiments, water (e.g., deionized water) may be added to the silver-containing solution and/or suspension until the ratio of the mass of water in the silver-containing solution and/or suspension to the combined mass of nitric and sulfuric acid in the silver-containing solution and/or suspension is at least 2:1, at least 3:1, at least 5:1, at least 10:1, at least 50:1, or at least 100:1. According to certain embodiments, after the diluted silver-containing solution and/or suspension is generated, the reducing agent and the diluted solution can be combined.

Silver, which can be transformed to high purity elemental silver according to certain embodiments, can be present in the solution and/or suspension in either or both of the dissolved form (e.g., in the form of silver ions, or silver complexes) and in the form of silver oxide or solid silver salt (e.g., powdered silver sulfate, silver acetate, silver carbonate, etc.). An unexpected and unpredicted development within the context of certain embodiments of the invention is the ability to use certain reducing agents to directly transform solids containing non-elemental silver (e.g., salts and oxides of silver, optionally in powdered form) into elemental silver. Accordingly, in certain embodiments, at least a portion (e.g., at least 10 wt %, at least 25 wt %, at least 50 wt %, at least 75 wt %, at least 90 wt %, at least 95 wt %, or at least 99 wt %) of the silver in non-elemental form within the silver-containing solution and/or suspension (which non-elemental silver is contacted with the reducing agent) is not solubilized (i.e., in the form of a solubilized ion or a solubilized silver complex). In some embodiments, at least a portion (e.g., at least 10 wt %, at least 25 wt %, at least 50 wt %, at least 75 wt %, at least 90 wt %, at least 95 wt %, or at least 99 wt %) of the silver in non-elemental form within the silver-containing solution and/or suspension (which non-elemental silver is contacted with the reducing agent) is part of a solid. In some embodiments, at least a portion (e.g., at least 10 wt %, at least 25 wt %, at least 50 wt %, at least 75 wt %, at least 90 wt %, at least 95 wt %, or at least 99 wt %) of the silver in non-elemental form within the silver-containing solution and/or suspension (which non-elemental silver is contacted with the reducing agent) is not part of a solubilized amine complex. In some embodiments, at least a portion (e.g., at least 10 wt %, at least 25 wt %, at least 50 wt %, at least 75 wt %, at least 90 wt %, at least 95 wt %, or at least 99 wt %) of the silver in non-elemental form within the silver-containing solution and/or suspension (which non-elemental silver is contacted with the reducing agent) is not part of a solubilized complex. According to certain embodiments, at least a portion (e.g., at least 10 wt %, at least 25 wt %, at least 50 wt %, at least 75 wt %, at least 90 wt %, at least 95 wt %, or at least 99 wt %) of the silver in non-elemental form within the silver-containing solution and/or suspension (which non-elemental silver is contacted with the reducing agent) is part of a silver salt (e.g., at least one of silver sulfate, silver acetate, and silver carbonate), part of a silver oxide, and/or part of a silver nitride.

According to some embodiments, at least a portion of the silver in non-elemental form within the silver-containing solution and/or suspension (which non-elemental silver is contacted with the reducing agent) is present on and/or within relatively large particles (relative to the size of solubilized silver ions and solubilized silver complexes). For example, in some embodiments, the silver-containing solution and/or suspension can contain silver-containing particles with relatively large maximum cross-sectional dimensions, and the silver within the relatively large particles can account for a relatively high percentage of the silver in non-elemental form in the silver-containing solution and/or suspension. For example, in some embodiments, the silver-containing solution and/or suspension may contain particles having maximum cross-sectional dimensions of at least 500 nm (or at least 1 micron, at least 1.5 microns, at least 2 microns, at least 2.5 microns, or at least 5 microns) and at least 10 wt % (or at least 25 wt %, at least 50 wt %, at least 75 wt %, at least 90 wt %, at least 95 wt %, or at least 99 wt %) of the silver in non-elemental form within the silver-containing solution and/or suspension is part of the particles having maximum cross-sectional dimensions of at least 500 nm (or at least 1 micron, at least 1.5 microns, at least 2 microns, at least 2.5 microns, or at least 5 microns).

According to certain embodiments (including, for example, some embodiments in which the solution and/or suspension containing silver in non-elemental form comprises a mixture of concentrated acid, which may be used to produce dissolved silver), at least one base metal may also be present (e.g., in dissolved form) in the silver containing solution and/or suspension. For example, in some embodiments, the solution and/or suspension containing the non-elemental silver may be produced by exposing a leaching solution (e.g., a mixture of strong acids) with an article comprising a silver-containing coating (e.g., elemental silver or silver alloy) on a base metal-containing substrate and/or to a silver alloy (e.g., containing silver and a base metal). In some such cases, the leaching solution is used to at least partially strip the silver-containing coating from the base metal substrate (e.g., a silver coating on a base metal substrate or silver present in the form a Ag—CdO plating on a copper substrate) and/or to at least partially remove the silver from the silver-containing alloy. In some such embodiments, a relatively large amount of base metal(s) may be dissolved in the leaching solution, which may create high concentrations of the dissolved base metals in the leaching solution, in addition to the dissolved silver. According to certain embodiments, after adding the reducing agent to the leaching solution, high purity silver may be recovered in a single step, even from solutions containing large amounts of dissolved base metals. Non-limiting examples of base metals include cadmium, copper, nickel, zinc, lead, and tin.

In some embodiments, a solid powdered fraction can accumulate in the leaching solutions (e.g., comprising a concentrated acid mixture). The solid powdered fraction can comprise primarily silver sulfate powder, as the majority of the other base metals, which may be present in such solutions, are much more soluble than silver (with the exception of lead, when present). In some embodiments, as described above, the solid silver-containing salt (e.g., silver sulfate powder) can be exposed to the reducing agent, and the silver within the solid silver-containing salt can be reduced to elemental silver, in some cases, without first solubilizing the silver from the silver-containing salt. In such a way, direct transformation of non-elemental silver in solid form (e.g., in powder form) to elemental silver can be achieved by the action of the added reducing agent, which can create high purity elemental silver.

In some embodiments, the reducing agent selectively reduces silver. For example, in some embodiments, the reducing agent reduces silver at a rate (based on mass) that is at least 5 times, at least 10 times, at least 20 times, at least 50 times, at least 100 times, or at least 1000 times faster than the rate (based on mass) at which base metals or other non-silver metals are reduced by the reducing agent. In certain embodiments, at least 50 wt %, at least 75 wt %, at least 90 wt %, at least 95 wt %, or at least 99 wt % of all metal that is reduced by the reducing agent is silver.

According to certain embodiments, the reducing agent can be capable of selectively reducing silver at low pH. The reduction at low pH is advantageous, according to certain but not necessarily all embodiments, as it may reduce or prevent co-precipitation of base metal-containing impurities, which may precipitate as, e.g., base metal oxides and/or base metal hydroxides at relatively low pH. Such precipitation may have an adverse impact on the purity of the recovered elemental silver. On the other hand, in certain cases, reduction at very low pH may lead to the overconsumption of the reducing agent. In some embodiments, the pH of the solution and/or suspension from which the elemental silver is recovered, after the non-elemental silver and the reducing agent have been combined, is less than 4.5, less than 4.0, less than 3.5, less than 3.0, or less than 2.5. In certain embodiments, the pH of the solution and/or suspension from which the elemental silver is recovered, after the non-elemental silver and the reducing agent have been combined, is at least 1.5 or at least 2.0. Combinations of these ranges are also possible.

According to certain embodiments, the reducing agent comprises an organic acid. In some embodiments, the reducing agent comprises an organic carboxylic acid, aldehyde, ester, or enediol. In certain embodiments, the organic carboxylic acid, ester, or aldehyde may further comprise an enediol moiety.

For example, in certain embodiments, the reducing agent comprises a compound of formula (I):

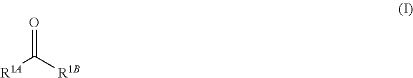

or salt thereof;
wherein:

R^{1A} is optionally substituted aliphatic, optionally substituted heteroaliphatic, optionally substituted aryl, or optionally substituted heteroaryl; and

R^{1B} is hydrogen to provide an aldehyde, or

R^{1B} is —OH to provide a carboxylic acid, or

R^{1B} is —OR⁴, wherein R⁴ is an optionally substituted aliphatic, optionally substituted heteroaliphatic, optionally substituted aryl, or optionally substituted heteroaryl group, to provide an ester,

optionally wherein R^{1A} and R^{1B} or R^{1A} and R⁴ are joined to form a 5- to 6-membered ring.

In certain embodiments, R^{1A} is optionally substituted aliphatic, e.g., optionally substituted C₁₋₁₀ alkyl or C₂₋₁₀ alkenyl. In certain embodiments, R^{1A} is C₁₋₁₀ alkyl or C₂₋₁₀ alkenyl comprising 1, 2, 3, 4, 5, 6, 7, or 8 hydroxyl (—OH) substituents. In certain embodiments, R^{1A} is C₁₋₁₀ alkyl or C₂₋₁₀ alkenyl comprising 1, 2, 3, 4, 5, 6, 7, or 8 hydroxyl (—OH) substituents and at least 1 oxo (=O) substituent. In certain embodiments, R^{1A} is C₂₋₆ alkyl comprising 1, 2, 3, 4, or 5 hydroxyl (—OH) substituents. In certain embodiments, R^{1A} is C₁ alkyl substituted by oxo (=O). In certain embodiments, R^{1A} is unsubstituted C₂₋₆ alkyl.

In certain embodiments, R^{1A} is an optionally substituted alkenyl of formula:

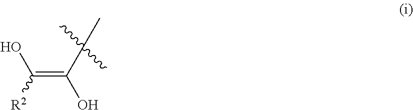

wherein R² is optionally substituted aliphatic, optionally substituted heteroaliphatic, optionally substituted aryl, or optionally substituted heteroaryl, or R² and R^{1B} or R² and R⁴ are joined to form a 5- to 6-membered ring.

In certain embodiments, R² is optionally substituted aliphatic, e.g., optionally substituted C₁₋₁₀ alkyl. In certain embodiments, R² is C₁₋₆ alkyl comprising 1, 2, 3, 4, or 5 hydroxyl (—OH) substituents. In certain embodiments, R² is C₁₋₆ alkyl comprising 1, 2, 3, 4, or 5 hydroxyl (—OH) substituents and at least 1 oxo (=O) substituent. In certain embodiments, R² and R⁴ are joined to form a 5- to 6-membered ring.

In certain embodiments, R^{1A} is optionally substituted aryl, e.g., optionally substituted phenyl. In certain embodiments, R^{1A} is phenyl comprising at least 1, 2, or 3 hydroxyl (—OH) substituents.

In certain embodiments, R^{1B} is hydrogen to provide an aldehyde of formula (I-a):

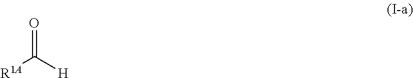

or salt thereof.

In certain embodiments, R^{1B} is —OH to provide a carboxylic acid of formula (I-b):

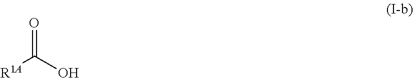

or salt thereof.

In certain embodiments, R^{1B} is —OR⁴ to provide an ester of formula (I-c):

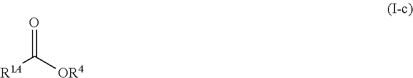

or salt thereof.

In certain embodiments, R⁴ is an optionally substituted heteroaliphatic, e.g., an optionally substituted 5- to 6-membered heterocyclic group. In certain embodiments, R⁴ is an optionally substituted 6-membered heterocyclic group comprising 1 or 2 heteroatoms selected from oxygen, nitrogen or sulfur. In certain embodiments, R⁴ is an optionally substituted tetrahydropyranyl ring.

In certain embodiments, the reducing agent comprises an enediol of formula (II):

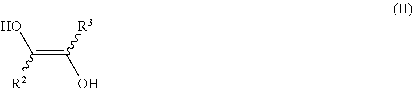

or salt thereof;
wherein:

R² is optionally substituted aliphatic, optionally substituted heteroaliphatic, optionally substituted aryl, or optionally substituted heteroaryl,

R³ is hydrogen, optionally substituted aliphatic, optionally substituted heteroaliphatic, optionally substituted aryl, optionally substituted heteroaryl, —C(═O)R⁴, or —C(═O)OR⁴;

R⁴ is hydrogen, optionally substituted aliphatic, optionally substituted heteroaliphatic, optionally substituted aryl, optionally substituted heteroaryl;

or R² and R⁴ are joined to form a 5- to 6-membered ring.

In certain embodiments, wherein R³ is —C(═O)OR⁴, the enediol of formula (II) is of formula (II-a):

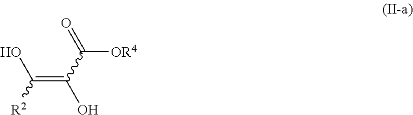

or salt thereof.

In certain embodiments, wherein R³ is —C(═O)R⁴, the enediol of formula (II) is of formula (II-b):

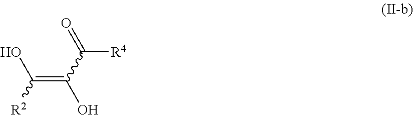

or salt thereof.

In certain embodiments, wherein R⁴ is hydrogen, the enediol of formula (II-a) or (II-b) is of formula (II-a-1) or (II-b-1):

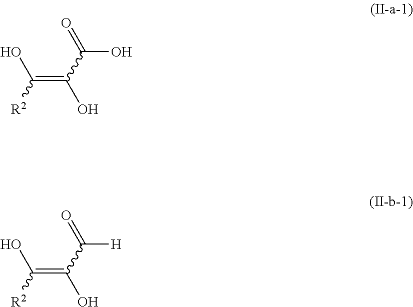

or salt thereof.

In certain embodiments, wherein R³ is —C(═O)R⁴ and R² and R⁴ are joined to form a 5-membered ring, the enediol of formula (II) is of formula (II-c):

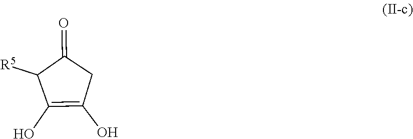

or salt thereof, wherein R⁵ is hydrogen, optionally substituted aliphatic, or optionally substituted heteroaliphatic.

In certain embodiments, wherein R³ is —C(═O)OR⁴ and R² and R⁴ are joined to form a 5-membered ring, the enediol of formula (II) is of formula (II-d):

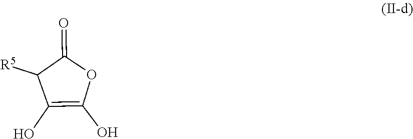

or salt thereof, wherein R⁵ is hydrogen, optionally substituted aliphatic, or optionally substituted heteroaliphatic.

In certain embodiments, R⁵ is optionally substituted aliphatic, e.g., optionally substituted C₁₋₄ alkyl or C₂₋₄ alkenyl. In certain embodiments, R⁵ is C₁₋₄ alkyl or C₂₋₄ alkenyl comprising 1, 2, or 3 hydroxyl (—OH) substituents. In certain embodiments, R⁵ is C₂ alkyl comprising 2 hydroxyl substituents.

Specific non-limiting examples of reducing agent components include L-ascorbic acid, reductic acid, glucic acid, erythorbic acid (also referred to as D-ascorbic acid, D-isoascorbic acid), gluconic acid, gallic acid, glyoxylic acid, propionic acid, tannic acid, tartaric acid, citric acid, lactic acid, their respective salts, and combinations of two or more of these. Chemical structures of these components are included in Table 1 below. According to certain embodiments, the reducing agent comprises a compound containing an enediol structure, optionally stabilized by conjugation and hydrogen bonding with an adjacent carbonyl group RC(OH)=C(OH)C(═O)R.

TABLE 1
Exemplary reducing agents.

| Reducing | |
|---|---|
| Agent | Chemical Structure |
| L-ascorbic acid | 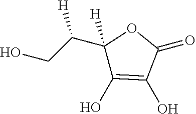 |
| Reductic acid | 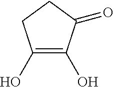 |
| Glucic acid | 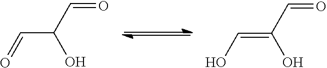 [SMILES: O=CC(O)C=O ; O=C/C(O)=C/O] |
| Erythorbic acid | 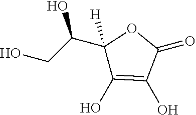 [SMILES: O=C1O[C@H]([C@H](O)CO)C(O)=C1O] |
| Gluconic acid | 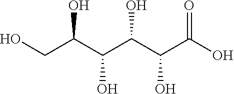 [SMILES: O=C(O)[C@H](O)[C@@H](O)[C@H](O)[C@H](O)CO] |
| Gallic acid | 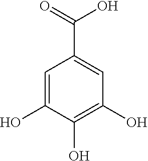 [SMILES: O=C(O)c1cc(O)c(O)c(O)c1] |
| Glyoxylic acid | 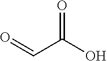 |
| Propionic acid | 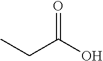 |
| Tannic acid | 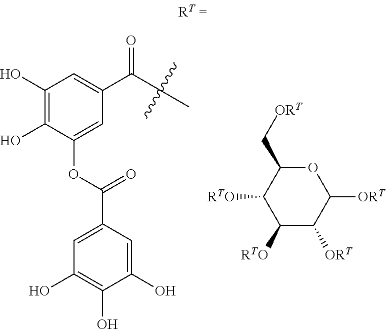 |
| Tartaric acid | 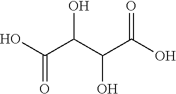 |
| Citric acid | 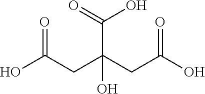 [SMILES: O=C(O)CC(O)(CC(=O)O)C(=O)O] |
| Lactic acid | 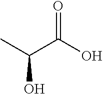 |

The reducing agents can be used alone or in combination. In some cases, for example, tannic acid at low pH is capable of only initiating the appearance of nano-sized silver clusters, which are generally not able to grow into large particles. In some such cases, addition of ascorbic acid can help to reduce and recover elemental silver. The quantity of ascorbic acid required in this exemplary embodiment is substantially less than the stoichiometric value necessary to accomplish complete reduction of silver by the action of ascorbic acid alone. This may be helpful in order to reduce the processing cost of silver recovery, as ascorbic acid can be expensive.

As noted above, in some embodiments, the silver-containing suspension and/or solution from which the elemental silver is recovered comprises or is derived from any of the leaching solutions described in International Patent Publication No. WO 2015/095664, published on Jun. 25, 2015, and entitled “Method and Apparatus for Recovery of Noble Metals, Including Recovery of Noble Metals from Plated and/or Filled Scrap” and/or International Patent Publication No. WO 2015/130965, published on Sep. 3, 2015, and entitled “Recovery of Gold and/or Silver from Scrap”, each of which is incorporated herein by reference in its entirety for all purposes. For example, in some embodiments, a silver-containing material (e.g., a material containing silver and at least one base metal) can be exposed to a leaching solution such that silver is removed from the silver-containing material to form non-elemental silver (e.g., in the form of a solid containing non-elemental silver, such as a silver-containing salt). Some such embodiments comprise combining the leaching solution containing the non-elemental silver with a reducing agent (e.g., any of the reducing agents described herein) such that at least a portion of the non-elemental silver is exposed to the reducing agent and converted to elemental silver.

In some embodiments, the silver-containing suspension and/or solution from which the elemental silver is recovered (and/or the leaching solution described above) comprises nitrate ions (e.g., nitric acid and/or a source of nitrate ions that are not nitric acid) and at least one supplemental acid. For example, in some embodiments, the silver-containing suspension and/or solution from which the elemental silver is recovered (and/or the leaching solution described above) comprises sulfuric acid and nitrate ions. In certain embodiments, the silver-containing suspension and/or solution from which the elemental silver is recovered (and/or the leaching solution described above) comprises phosphoric acid and nitrate ions. In some embodiments, the amount of nitrate ions within the silver-containing suspension and/or solution from which the elemental silver is recovered (and/or the leaching solution described above) may be relatively small compared to the amount of supplemental acid(s) (e.g., sulfuric acid or phosphoric acid) within the suspension and/or solution (and/or the leaching solution). According to some embodiments, highly concentrated acids may be present in the silver-containing suspension and/or solution from which the elemental silver is recovered (and/or the leaching solution described above), for example, such that the suspension and/or solution (and/or leaching solution) contains a relatively small amount of water.

In some embodiments, the silver-containing suspension and/or solution from which the elemental silver is recovered (and/or the leaching solution described above) comprises nitrate ions and at least one supplemental acid. In some such embodiments, the amount of nitrate ions within the suspension and/or solution is less than or equal to about 10 wt %, less than or equal to about 9 wt %, less than or equal to about 8 wt %, less than or equal to about 7 wt %, less than or equal to about 6 wt %, less than or equal to about 5 wt %, less than or equal to about 4 wt %, less than or equal to about 3 wt %, less than or equal to about 2 wt %, less than or equal to about 1 wt %, or less. In some embodiments, the amount of nitrate ions within the suspension and/or solution is as little as about 4 wt %, as little as about 3 wt %, at little as about 2 wt %, as little as about 1 wt %, as little as about 0.5 wt %, as little as about 0.1 wt %, or less. In some embodiments, the amount of nitrate ions within the suspension and/or solution is as little as about 0.07 wt %, as little as about 0.05 wt %, at little as about 0.02 wt %, as little as about 0.01 wt %, or less.

The nitrate ions can originate from a number of sources. In some embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the nitrate ions originate from nitric acid and/or a nitrate salt. In certain embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the nitrate ions originate from nitric acid. In certain embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the nitrate ions originate from a source that is not nitric acid. In some embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the nitrate ions originate from a nitrate salt. The nitrate salt may include, for example, nitrate ions ionically bonded to one or more metal ions. Non-limiting examples of nitrate salts include, but are not limited to, sodium nitrate (NaNO₃), potassium nitrate (KNO₃), magnesium nitrate (Mg(NO₃)₂), calcium nitrate (Ca(NO₃)₂), strontium nitrate (Sr(NO₃)₂), and barium nitrate (Ba(NO₃)₂). In some embodiments, the nitrate salt is substantially completely soluble in the silver-containing suspension and/or solution from which the elemental silver is recovered (and/or in the leaching solution described above).

In some embodiments, the silver-containing suspension and/or solution from which the elemental silver is recovered (and/or the leaching solution described above) comprises nitric acid and at least one supplemental acid. In some such embodiments, the amount of nitric acid within the suspension and/or solution is less than or equal to about 10 wt %, less than or equal to about 9 wt %, less than or equal to about 8 wt %, less than or equal to about 7 wt %, less than or equal to about 6 wt %, less than or equal to about 5 wt %, less than or equal to about 4 wt %, less than or equal to about 3 wt %, less than or equal to about 2 wt %, less than or equal to about 1 wt %, or less. In some embodiments, the amount of nitric acid within the suspension and/or solution is as little as about 4 wt %, as little as about 3 wt %, at little as about 2 wt %, as little as about 1 wt %, as little as about 0.5 wt %, as little as about 0.1 wt %, or less. In some embodiments, the amount of nitric acid within the suspension and/or solution is as little as about 0.07 wt %, as little as about 0.05 wt %, at little as about 0.02 wt %, as little as about 0.01 wt %, or less.

A variety of acids can be used as the supplemental acid. In some embodiments, the supplemental acid(s) is capable of forming an insoluble salt with noble metal(s) within the mixture. For example, in some embodiments, phosphoric acid and/or sulfuric acid can be used in combination with the nitric acid.

According to certain embodiments, the supplemental acid comprises a sulfonic acid. For example, the silver-containing suspension and/or solution from which the elemental silver is recovered (and/or the leaching solution described above) may comprise, according to certain embodiments, a solution (e.g., an aqueous solution) of nitrate ions (e.g., nitric acid and/or a source of nitrate ions that is not nitric acid) and a sulfonic acid. In some, although not necessarily all, embodiments, it may be advantageous to use nitric acid as the source of nitrate ions when sulfonic acid is employed in the silver-containing suspension and/or solution from which the elemental silver is recovered (and/or in the leaching solution described above). In some such embodiments, the silver-containing suspension and/or solution from which the elemental silver is recovered (and/or the leaching solution described above) may also comprise an additional supplemental acid, such as sulfuric acid and/or phosphoric acid.

In certain embodiments, the silver-containing suspension and/or solution from which the elemental silver is recovered (and/or the leaching solution described above) comprises at least one sulfonic acid represented by:

RS(═O)₂—OH,

wherein R is an alkyl group containing 1-12 carbon atoms, an alkenyl group containing 1-12 carbon atoms, a hydroxyalkyl group containing 1-12 carbon atoms, or an aryl group containing 6-12 carbon atoms. In some embodiments, the leaching solution comprises an alkanesulfonic acid comprising an alkyl group containing 1-5 carbon atoms. Combinations of these may also be used.

According to certain embodiments, the supplemental acid of the silver-containing suspension and/or solution from which the elemental silver is recovered (and/or the leaching solution described above) comprises an alkane sulfonic acid. Examples of suitable alkane sulfonic acids that can be used include, but are not limited to, ethanesulfonic acid, propanesulfonic acid, isopropanesulfonic acid, butanesulfonic acid, isobutanesulfonic acid, methanesulfonic acid, and combinations of two or more of these. In some embodiments, alkane sulfonic acid can be part of an aqueous solution used as a leaching solution. The silver-containing suspension and/or solution from which the elemental silver is recovered (and/or the leaching solution described above) can contain, according to certain embodiments, the alkane sulfonic acid and nitrate ions (e.g., nitric acid and/or a source of nitrate ions that is not nitric acid). In some embodiments, the silver-containing suspension and/or solution from which the elemental silver is recovered (and/or the leaching solution described above) can contain an alkane sulfonic acid, nitrate ions, and at least one additional supplemental acid (e.g., sulfuric acid and/or phosphoric acid).

In some embodiments, the supplemental acid of the silver-containing suspension and/or solution from which the elemental silver is recovered (and/or the leaching solution described above) comprises methanesulfonic acid. Methanesulfonic acid is a strong organic acid that is generally substantially completely non-oxidizing at high concentrations, and that generally forms highly soluble salts with many metals. Methanesulfonic acid generally has a high dissociation constant, and is therefore a good electrolyte. Methanesulfonic acid also has substantially no odor, and it is sometimes described as being a “green acid” because of its ecological advantages (e.g., readily biodegradable, virtually VOC free, having low TOC, making hardly any contribution to COD, being free of nitrogen, phosphorus and halogens, etc.).

According to certain embodiments, the silver-containing suspension and/or solution from which the elemental silver is recovered (and/or the leaching solution described above) comprises persulfuric acid. The persulfuric acid may be present in place of or in addition to a sulfonic acid in the suspension and/or solution (including any of the sulfonic acids mentioned elsewhere herein, and mixtures of these).

In some embodiments, the silver-containing suspension and/or solution from which the elemental silver is recovered (and/or the leaching solution described above) comprises a peroxymonosulfate ion(SO₅²⁻) and/or a peroxydisulfate ion (S₂O₈²⁻). The peroxymonosulfate ions and/or peroxydisulfate ions may be present in place of or in addition to a sulfonic acid in the suspension and/or solution (including any of the sulfonic acids mentioned elsewhere herein, and mixtures of these).

According to certain embodiments, the silver-containing suspension and/or solution from which the elemental silver is recovered (and/or the leaching solution described above) comprises sulfamate ions. The sulfamate ions can originate from a number of sources. In some embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the sulfamate ions originate from sulfamic acid and/or a sulfamate salt. In certain embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the sulfamate ions originate from sulfamic acid. In certain embodiments, at least a portion (e.g., at least about 1 wt %, at least about 5 wt %, at least about 10 wt %, at least about 25 wt %, at least about 50 wt %, at least about 75 wt %, at least about 90 wt %, at least about 95 wt %, at least about 99 wt %, or all) of the sulfamate ions originate from a sulfamate salt. The sulfamate salt may include, for example, sulfamate ions ionically bonded to one or more metal ions. The sulfamate salt may include, for example, ammonium sulfamate, sodium sulfamate, potassium sulfamate, calcium sulfamate, and/or combinations of two or more of these.

In some, although not necessarily all, embodiments, it may be advantageous to use nitric acid as the source of nitrate ions when sulfamate ions are employed in the silver-containing suspension and/or solution from which the elemental silver is recovered (and/or in the leaching solution described above).

In certain embodiments, the total amount of sulfamate ions in the silver-containing suspension and/or solution from which the elemental silver is recovered (and/or the leaching solution described above) is less than or equal to about 10 wt %, less than or equal to about 9 wt %, less than or equal to about 8 wt %, less than or equal to about 7 wt %, less than or equal to about 6 wt %, less than or equal to about 5 wt %, less than or equal to about 4 wt %, less than or equal to about 3 wt %, or less than or equal to about 2 wt % (and/or, in some embodiments, at least about 0.001 wt %, at least about 0.01 wt %, at least about 0.1 wt %, at least about 1 wt %, or at least about 2 wt %).

According to certain embodiments, the silver-containing suspension and/or solution from which the elemental silver is recovered (and/or the leaching solution described above) comprises ammonium. In some, although not necessarily all, embodiments, it may be advantageous to use nitric acid as the source of nitrate ions when ammonium is employed in the silver-containing suspension and/or solution from which the elemental silver is recovered (and/or the leaching solution described above).

In certain embodiments, the total amount of ammonium in the silver-containing suspension and/or solution from which the elemental silver is recovered (and/or the leaching solution described above) is less than or equal to about 5 wt %, less than or equal to about 4.5 wt %, less than or equal to about 4 wt %, less than or equal to about 3.5 wt %, less than or equal to about 3 wt %, less than or equal to about 2.5 wt %, or less than or equal to about 2 wt % (and/or, in some embodiments, at least about 0.001 wt %, at least about 0.01 wt %, at least about 0.1 wt %, at least about 1 wt %, or at least about 2 wt %).

According to certain embodiments, the silver-containing suspension and/or solution from which the elemental silver is recovered (and/or the leaching solution described above) comprises acetic acid. In some, although not necessarily all, embodiments, it may be advantageous to use nitric acid as the source of nitrate ions when acetic acid is employed in the silver-containing suspension and/or solution from which the elemental silver is recovered (and/or in the leaching solution described above).

In certain embodiments, the total amount of acetic acid in the silver-containing suspension and/or solution from which the elemental silver is recovered (and/or the leaching solution described above) is less than or equal to about 5 wt %, less than or equal to about 4.5 wt %, less than or equal to about 4 wt %, less than or equal to about 3.5 wt %, less than or equal to about 3 wt %, less than or equal to about 2.5 wt %, or less than or equal to about 2 wt % (and/or, in some embodiments, at least about 0.001 wt %, at least about 0.01 wt %, at least about 0.1 wt %, at least about 1 wt %, or at least about 2 wt %).

In some embodiments, the weight ratio of the supplemental acid within the silver-containing suspension and/or solution from which the elemental silver is recovered (and/or the leaching solution described above) to the nitrate ions (e.g., nitric acid and/or a source of nitrate ions that is not nitric acid) within the silver-containing suspension and/or solution from which the elemental silver is recovered (and/or the leaching solution described above) is relatively high. For example, in some embodiments, the ratio of the weight of the at least one supplemental acid in the mixture to the weight of the nitrate ions in the mixture is at least about 3:1, at least about 4:1, at least about 5:1, at least about 6:1, at least about 7:1, at least about 8:1, at least about 9:1, at least about 10:1, at least about 11:1, at least about 12:1, at least about 13:1, at least about 14:1, at least about 15:1, or at least about 17:1 (and/or, in certain embodiments, up to about 20:1, up to about 50:1, up to about 100:1, or more). When more than one supplemental acid is present, the ratio of the weight of the at least one supplemental acid to the weight of the nitrate ions is calculated by adding the weights of all supplemental acids within the mixture together, and comparing this number to the weight of the nitrate ions within the mixture. In some embodiments, the ratio of the combined weights of sulfuric acid and phosphoric acid in the mixture to the weight of the nitrate ions in the mixture is at least about 3:1, at least about 4:1, at least about 5:1, at least about 6:1, at least about 7:1, at least about 8:1, at least about 9:1, at least about 10:1, at least about 11:1, at least about 12:1, at least about 13:1, at least about 14:1, at least about 15:1, or at least about 17:1 (and/or, in certain embodiments, up to about 20:1, up to about 50:1, up to about 100:1, or more).

In certain embodiments, the weight ratio of sulfuric acid to nitrate ions (e.g., nitric acid and/or a source of nitrate ions that is not nitric acid) in the silver-containing suspension and/or solution from which the elemental silver is recovered (and/or the leaching solution described above) is relatively high. In some such embodiments, the weight ratio of sulfuric acid to nitrate ions within the silver-containing suspension and/or solution from which the elemental silver is recovered (and/or the leaching solution described above) is at least about 12:1, at least about 13:1, at least about 14:1, at least about 15:1, or at least about 17:1 (and/or, in certain embodiments, up to about 20:1, up to about 50:1, up to about 100:1, or more). For example, in one set of embodiments, the silver-containing suspension and/or solution from which the elemental silver is recovered (and/or the leaching solution described above) includes 90 wt % or more of concentrated sulfuric acid (e.g., at least 95 wt % sulfuric acid, such as 95-98 wt % sulfuric acid, the balance of which may be, for example, water) and 10 wt % or less of concentrated nitric acid (e.g., at least 68 wt % nitric acid, such as 68-70 wt % nitric acid, the balance of which may be, for example, water).

In certain embodiments, the weight ratio of phosphoric acid to nitrate ions (e.g., nitric acid and/or a source of nitrate ions that is not nitric acid) in the silver-containing suspension and/or solution from which the elemental silver is recovered (and/or the leaching solution described above) is relatively high. For example, in some embodiments, the weight ratio of phosphoric acid to nitrate ions within the silver-containing suspension and/or solution from which the elemental silver is recovered (and/or the leaching solution described above) is at least about 11:1, at least about 12:1, at least about 13:1, at least about 14:1, at least about 15:1, or at least about 17:1 (and/or, in certain embodiments, up to about 20:1, up to about 50:1, up to about 100:1,or more).

In one set of embodiments, the silver-containing suspension and/or solution from which the elemental silver is recovered (and/or the leaching solution described above) includes 90 wt % or more of concentrated phosphoric acid (e.g., 85 wt % phosphoric acid or stronger, the balance of which may be, for example, water) and 10 wt % or less of concentrated nitric acid (e.g., at least 68 wt % nitric acid, such as 68-70 wt % nitric acid, the balance of which may be, for example, water).

In certain embodiments, an oxidant can be used (in place of, or in addition to, the nitrate ions) in the silver-containing suspension and/or solution from which the elemental silver is recovered (and/or in the leaching solution described above). In some such embodiments, the amount of the oxidant within the fluid is less than or equal to about 10 wt %, less than or equal to about 9 wt %, less than or equal to about 8 wt %, less than or equal to about 7 wt %, less than or equal to about 6 wt %, or less than or equal to about 5 wt % (and/or, in some embodiments, as little as about 4 wt %, as little as about 3 wt %, at little as about 2 wt %, as little as about 1 wt %, or less). A variety of such oxidants may be used. In some embodiments, an oxidant with the ability to dissolve noble metal(s) is selected for use. In some embodiments, the oxidant can be in the form of a soluble salt. In certain embodiments, the soluble salt comprises an oxide of manganese, nickel, lead, and/or chromium. One non-limiting example of an oxidant that may be used is manganese dioxide (MnO₂). In some embodiments, the silver-containing suspension and/or solution from which the elemental silver is recovered (and/or the leaching solution described above) comprises the oxidant (e.g., MnO₂) and at least one supplemental acid (e.g., phosphoric acid and/or sulfuric acid). For example, in some embodiments, mixtures comprising an oxidant (e.g., MnO₂) and sulfuric acid and/or phosphoric acid may be used. Any of the supplemental acids described elsewhere herein can, according to certain embodiments, be used in combination with the oxidant. In some embodiments, the oxidant is capable of producing oxygen by reacting with the supplemental acid (e.g., phosphoric acid and/or sulfuric acid). For example, when manganese oxide and sulfuric acid are used, manganese oxide can react with sulfuric acid to produce manganese sulfate (MnSO₄), oxygen gas (O₂), and water.

In some embodiments, the amount of water contained in the silver-containing suspension and/or solution from which the elemental silver is recovered (and/or the leaching solution described above) is relatively low. For example, in some embodiments, the silver-containing suspension and/or solution from which the elemental silver is recovered (and/or the leaching solution described above) contains water in an amount of less than or equal to about 17 w % (or less than about 16 wt %, less than about 15 wt %, less than about 14 wt %, less than about 13 wt %, less than about 12 wt %, less than about 11 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt %). In certain embodiments, as described above, the mixture comprises supplemental acids, such as phosphoric acid and/or sulfuric acid.

In certain embodiments, the silver-containing suspension and/or solution from which the elemental silver is recovered (and/or the leaching solution described above) comprises sulfuric acid, and the amount of water within the suspension and/or solution is less than about 8 wt % (or less than about 7 wt %, less than about 6 wt %, less than about 5 wt %, less than about 4 wt %, less than about 3 wt %, less than about 2 wt %, or less than about 1 wt %).

For example, in some embodiments, the silver-containing suspension and/or solution from which the elemental silver is recovered (and/or the leaching solution described above) contains a mixture of sulfuric acid and nitrate ions (e.g., nitric acid and/or a source of nitrate ions that is not nitric acid), and the amount of water within the solution and/or suspension is less than about 8 wt % (or less than about 7 wt %, less than about 6 wt %, less than about 5 wt %, less than about 4 wt %, less than about 3 wt %, less than about 2 wt %, or less than about 1 wt %). In certain embodiments, the silver-containing suspension and/or solution from which the elemental silver is recovered (and/or the leaching solution described above) contains a mixture of phosphoric acid and nitrate ions (e.g., nitric acid and/or a source of nitrate ions that is not nitric acid), and the amount of water within the mixture is less than about 17 wt % (or less than about 16 wt %, less than about 15 wt %, less than about 14 wt %, less than about 13 wt %, less than about 12 wt %, less than about 11 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt %).

In some embodiments, the silver-containing suspension and/or solution from which the elemental silver is recovered (and/or the leaching solution described above) contains nitrate ions (e.g., in any of the amounts described above) and a relatively large amount of at least one supplemental acid. In some embodiments, the silver-containing suspension and/or solution from which the elemental silver is recovered (and/or the leaching solution described above) contains supplemental acid in an amount of at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 97 wt %, or at least about 98 wt %. In some embodiments, the silver-containing suspension and/or solution from which the elemental silver is recovered (and/or the leaching solution described above) contains supplemental acid in an amount of less than or equal to about 99 wt %, less than or equal to about 98 wt %, less than or equal to about 95 wt %, less than or equal to about 90 wt %, less than or equal to about 85 wt %, less than or equal to about 80 wt %, or less than or equal to about 75 wt %. When more than one supplemental acid is present in the solution and/or suspension, the weight percentage of the supplemental acid in the solution and/or suspension is calculated by summing the weight percentages of each supplemental acid in the solution and/or suspension. For example, if the solution and/or suspension contains 85 wt % sulfuric acid and 5 wt % phosphoric acid, the solution and/or suspension would be said to contain 90 wt % supplemental acids.

In some embodiments, the silver-containing suspension and/or solution from which the elemental silver is recovered (and/or the leaching solution described above) contains sulfuric acid in an amount of at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 97 wt %, or at least about 98 wt %. In some embodiments, the silver-containing suspension and/or solution from which the elemental silver is recovered (and/or the leaching solution described above) contains sulfuric acid in an amount of less than or equal to about 99 wt %, less than or equal to about 98 wt %, less than or equal to about 95 wt %, less than or equal to about 90 wt %, less than or equal to about 85 wt %, less than or equal to about 80 wt %, or less than or equal to about 75 wt %. In some embodiments, the silver-containing suspension and/or solution from which the elemental silver is recovered (and/or the leaching solution described above) contains phosphoric acid in an amount of at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, at least about 97 wt %, or at least about 98 wt %. In some embodiments, the silver-containing suspension and/or solution from which the elemental silver is recovered (and/or the leaching solution described above) contains phosphoric acid in an amount of less than or equal to about 99 wt %, less than or equal to about 98 wt %, less than or equal to about 95 wt %, less than or equal to about 90 wt %, less than or equal to about 85 wt %, less than or equal to about 80 wt %, or less than or equal to about 75 wt %.

In certain embodiments, the total amount of sulfonic acids (e.g., methanesulfonic acid and/or any other sulfonic acid, alone or in combination) in the silver-containing suspension and/or solution from which the elemental silver is recovered (and/or in the leaching solution described above) is at least about 50 wt %, at least about 55 wt %, at least about 60 wt %, at least about 65 wt %, at least about 75 wt %, at least about 80 wt %, at least about 85 wt %, at least about 90 wt %, at least about 95 wt %, at least about 97 wt %, or at least about 98 wt %. In some embodiments, the total amount of sulfonic acids (e.g., methanesulfonic acid and/or any other sulfonic acid, alone or in combination) in the silver-containing suspension and/or solution from which the elemental silver is recovered (and/or in the leaching solution described above) is less than or equal to about 99 wt %, less than or equal to about 98 wt %, less than or equal to about 95 wt %, less than or equal to about 90 wt %, or less than or equal to about 85 wt %. In some such embodiments in which the concentration of sulfonic acid(s) is relatively high, the sulfonic acid(s) can be used as the main supplemental acid in the solution mixture. In some embodiments, lower amounts of sulfonic acid(s) can be used. For example, in some embodiments, the total amount of sulfonic acids (e.g., methanesulfonic acid and/or any other sulfonic acid, alone or in combination) in the silver-containing suspension and/or solution from which the elemental silver is recovered (and/or in the leaching solution described above) is less than about 25 wt %, less than about 24 wt %, less than about 23 wt %, less than about 22 wt %, less than about 21 wt %, less than about 20 wt %, less than about 15 wt %, or less than about 10 wt % (and/or, in some embodiments, as little as about 5 wt %, as little as about 2 wt %, as little as about 1 wt %, as little as about 0.1 wt %, or less). In some embodiments, the total amount of sulfonic acid(s) in the silver-containing suspension and/or solution from which the elemental silver is recovered (and/or in the leaching solution described above) is less than about 25 wt % (or less than about 24 wt %, less than about 23 wt %, less than about 22 wt %, less than about 21 wt %, less than about 20 wt %, less than about 15 wt %, less than about 10 wt % and/or as little as about 5 wt %, as little as about 2 wt %, as little as about 1 wt %, as little as about 0.1 wt %, or less) when the sulfonic acid is used in combination with nitrate ions (e.g., in any of the amounts described elsewhere herein) and at least one additional supplemental acid (e.g., sulfuric acid and/or phosphoric acid, for example, in any of the amounts described elsewhere herein).

In certain embodiments, the total amount of alkane sulfonic acids in the silver-containing suspension and/or solution from which the elemental silver is recovered (and/or the leaching solution described above) is at least about 50 wt %, at least about 75 wt %, at least about 80 wt %, at least about 85 wt %, at least about 90 wt %, at least about 95 wt %, at least about 97 wt %, or at least about 98 wt %. In some embodiments, the total amount of alkanesulfonic acids in the silver-containing suspension and/or solution from which the elemental silver is recovered (and/or the leaching solution described above) is less than or equal to about 99 wt %, less than or equal to about 98 wt %, less than or equal to about 95 wt %, less than or equal to about 90 wt %, or less than or equal to about 85 wt %. In some embodiments, lower amounts of alkanesulfonic acid(s) can be used. For example, in some embodiments, the total amount of alkanesulfonic acids in the silver-containing suspension and/or solution from which the elemental silver is recovered (and/or the leaching solution described above) is less than about 25 wt %, less than about 24 wt %, less than about 23 wt %, less than about 22 wt %, less than about 21 wt %, less than about 20 wt %, less than about 15 wt %, or less than about 10 wt % (and/or, in some embodiments, as little as about 5 wt %, as little as about 2 wt %, as little as about 1 wt %, as little as about 0.1 wt %, or less). In some embodiments, the total amount of alkanesulfonic acid(s) in the silver-containing suspension and/or solution from which the elemental silver is recovered (and/or the leaching solution described above) is less than about 25 wt % (or less than about 24 wt %, less than about 23 wt %, less than about 22 wt %, less than about 21 wt %, less than about 20 wt %, less than about 15 wt %, less than about 10 wt % and/or as little as about 5 wt %, as little as about 2 wt %, as little as about 1 wt %, as little as about 0.1 wt %, or less) when the alkanesulfonic acid is used in combination with nitrate ions (e.g., in any of the amounts described elsewhere herein) and at least one additional supplemental acid (e.g., sulfuric acid and/or phosphoric acid, for example, in any of the amounts described elsewhere herein).

In certain embodiments, the total amount of methanesulfonic acid in the silver-containing suspension and/or solution from which the elemental silver is recovered (and/or the leaching solution described above) is at least about 50 wt %, at least about 75 wt %, at least about 80 wt %, at least about 85 wt %, at least about 90 wt %, at least about 95 wt %, at least about 97 wt %, or at least about 98 wt %. In some embodiments, the total amount of methanesulfonic acid in the silver-containing suspension and/or solution from which the elemental silver is recovered (and/or the leaching solution described above) is less than or equal to about 99 wt %, less than or equal to about 98 wt %, less than or equal to about 95 wt %, less than or equal to about 90 wt %, or less than or equal to about 85 wt %. In some embodiments, lower amounts of methanesulfonic acid can be used. For example, in some embodiments, the total amount of methanesulfonic acid in the silver-containing suspension and/or solution from which the elemental silver is recovered (and/or the leaching solution described above) is less than about 25 wt %, less than about 24 wt %, less than about 23 wt %, less than about 22 wt %, less than about 21 wt %, less than about 20 wt %, less than about 15 wt %, or less than about 10 wt % (and/or, in some embodiments, as little as about 5 wt %, as little as about 2 wt %, as little as about 1 wt %, as little as about 0.1 wt %, or less). In some embodiments, the total amount of methanesulfonic acid in the silver-containing suspension and/or solution from which the elemental silver is recovered (and/or the leaching solution described above) is less than about 25 wt % (or less than about 24 wt %, less than about 23 wt %, less than about 22 wt %, less than about 21 wt %, less than about 20 wt %, less than about 15 wt %, less than about 10 wt % and/or as little as about 5 wt %, as little as about 2 wt %, as little as about 1 wt %, as little as about 0.1 wt %, or less) when the methanesulfonic acid is used in combination with nitrate ions (e.g., in any of the amounts described elsewhere herein) and at least one additional supplemental acid (e.g., sulfuric acid and/or phosphoric acid, for example, in any of the amounts described elsewhere herein).

In certain embodiments, the silver-containing suspension and/or solution from which the elemental silver is recovered (and/or the leaching solution described above) comprises nitrate ions (e.g., nitric acid and/or a source of nitrate ions that is not nitric acid), at least one sulfonic acid, and at least one additional (non-sulfonic) supplemental acid (e.g., sulfuric acid and/or phosphoric acid). In some such embodiments, the amount of nitrate ions within the silver-containing suspension and/or solution from which the elemental silver is recovered (and/or the leaching solution described above) is less than or equal to about 10 wt %, less than or equal to about 9 wt %, less than or equal to about 8 wt %, less than or equal to about 7 wt %, less than or equal to about 6 wt %, less than or equal to about 5 wt %, less than or equal to about 4 wt %, less than or equal to about 3 wt %, less than or equal to about 2 wt %, less than or equal to about 1 wt %, or less, and/or as little as about 4 wt %, as little as about 3 wt %, at little as about 2 wt %, as little as about 1 wt %, as little as about 0.5 wt %, as little as about 0.1 wt %, as little as about 0.07 wt %, as little as about 0.05 wt %, at little as about 0.02 wt %, as little as about 0.01 wt %, or less. In some such embodiments, the total amount of sulfonic acids (e.g., methanesulfonic acid and/or any other sulfonic acid, alone or in combination) in the silver-containing suspension and/or solution from which the elemental silver is recovered (and/or the leaching solution described above) is less than about 25 wt %, less than about 24 wt %, less than about 23 wt %, less than about 22 wt %, less than about 21 wt %, less than about 20 wt %, less than about 15 wt %, or less than about 10 wt % (and/or, in some embodiments, as little as about 5 wt %, as little as about 2 wt %, as little as about 1 wt %, as little as about 0.1 wt %, or less). In some embodiments, the total amount of the at least one additional (non-sulfonic) supplemental acid is at least about 50 wt %, at least about 65 wt %, at least about 70 wt %, at least about 75 wt %, at least about 80 wt %, at least about 85 wt %, at least about 90 wt %, at least about 95 wt %, at least about 97 wt %, at least about 98 wt %, and/or less than or equal to about 99 wt %, less than or equal to about 98 wt %, less than or equal to about 95 wt %, less than or equal to about 90 wt %, less than or equal to about 85 wt %, less than or equal to about 80 wt %, or less than or equal to about 75 wt %.

In some embodiments, the weight proportion of water to concentrated acid solution can be 3:1 or higher (and, in some embodiments, may be from 3:1 to below 5:1). In certain embodiments, the weight proportion of water to concentrated acid solution can be 5:1 or higher (and, in some embodiments, may be from 5:1 to below 10:1). In certain embodiments, the weight proportion of water to concentrated acid solution can be 10:1 or higher.

### Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, E. L. Stereochemistry of Carbon Compounds (McGraw-Hill, N Y, 1962); and Wilen, S. H. Tables of Resolving Agents and Optical Resolutions p. 268 (E. L. Eliel, Ed., Univ. of Notre Dame Press, Notre Dame, Ind. 1972). The invention additionally encompasses compounds as individual isomers substantially free of other isomers, and alternatively, as mixtures of various isomers.

When a range of values is listed, it is intended to encompass each value and sub-range within the range. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “aliphatic,” as used herein, refers to alkyl, alkenyl, alkynyl, and carbocyclic groups. Likewise, the term “heteroaliphatic” as used herein, refers to heteroalkyl, heteroalkenyl, heteroalkynyl, and heterocyclic groups.

As used herein, “alkyl” refers to a radical of a straight-chain or branched saturated hydrocarbon group having from 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈) and the like. Unless otherwise specified, each instance of an alkyl group is independently unsubstituted (an “unsubstituted alkyl”) or substituted (a “substituted alkyl”) with one or more substituents. In certain embodiments, the alkyl group is an unsubstituted C₁₋₁₀ alkyl (e.g., —CH₃). In certain embodiments, the alkyl group is a substituted C₁₋₁₀ alkyl.

As used herein, “heteroalkyl” refers to an alkyl group as defined herein which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 10 carbon atoms and 1 or more heteroatoms within the parent chain (“heteroC₁₋₁₀ alkyl”). In some embodiments, a heteroalkyl group is a saturated group having 1 to 9 carbon atoms and 1 or more heteroatoms within the parent chain (“heteroC₁₋₉ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 7 carbon atoms and 1 or more heteroatoms within the parent chain (“heteroC₁₋₇ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 5 carbon atoms and 1 or 2 heteroatoms within the parent chain (“heteroC₁₋₅ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, a heteroalkyl group is a saturated group having 2 to 6 carbon atoms and 1 or 2 heteroatoms within the parent chain (“heteroC₂₋₆ alkyl”). Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₁₀ alkyl. In certain embodiments, the heteroalkyl group is a substituted heteroC₁₋₁₀ alkyl.

As used herein, “alkenyl” refers to a radical of a straight-chain or branched hydrocarbon group having from 2 to 10 carbon atoms and one or more carbon-carbon double bonds (e.g., 1, 2, 3, or 4 double bonds). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl.

As used herein, “heteroalkenyl” refers to an alkenyl group as defined herein which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”). In some embodiments, a heteroalkenyl group has 2 to 8 carbon atoms, at least one double bond, and 1 or more heteroatoms within the parent chain (“heteroC₂₋g alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

As used herein, “alkynyl” refers to a radical of a straight-chain or branched hydrocarbon group having from 2 to 10 carbon atoms and one or more carbon-carbon triple bonds (e.g., 1, 2, 3, or 4 triple bonds) (“C₂₋₁₀ alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

As used herein, “heteroalkynyl” refers to an alkynyl group as defined herein which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”).

In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

As used herein, “carbocyclyl” or “carbocyclic” refers to a radical of a non-aromatic cyclic hydrocarbon group having from 3 to 10 ring carbon atoms (“C₃₋₁₀ carbocyclyl”) and zero heteroatoms in the non-aromatic ring system. In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 4 to 6 ring carbon atoms (“C₄₋₆ carbocyclyl”). In some embodiments, a carbocyclyl group has 5 to 6 ring carbon atoms (“C₅₋₆ carbocyclyl”). In some embodiments, a carbocyclyl group has 5 to ring carbon atoms (“C₅₋₁₀ carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋g carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃ g carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₀ carbocyclyl. In certain embodiments, the carbocyclyl group is a substituted C₃₋₁₀ carbocyclyl.

As used herein, “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include, without limitation, azirdinyl, oxiranyl, and thiiranyl. Exemplary 4-membered heterocyclyl groups containing 1 heteroatom include, without limitation, azetidinyl, oxetanyl and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinanyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, indolinyl, phthalimidyl, naphthalimidyl, chromanyl, chromenyl, and the like.

As used herein, “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents.

In certain embodiments, the aryl group is an unsubstituted C₆₋₁₄ aryl. In certain embodiments, the aryl group is a substituted C₁₄ aryl.

As used herein, “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include, without limitation, pyrrolyl, furanyl and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl and phenazinyl.

As used herein, the term “partially unsaturated” refers to a ring moiety that includes at least one double or triple bond. The term “partially unsaturated” is intended to encompass rings having multiple sites of unsaturation, but is not intended to include aromatic groups (e.g., aryl or heteroaryl moieties) as herein defined.

As used herein, the term “saturated” refers to a ring moiety that does not contain a double or triple bond, i.e., the ring contains all single bonds.

As understood from the above, alkyl, alkenyl, alkynyl, heteroalkyl, heteroalkenyl, heteroalkynyl, carbocyclyl, heterocyclyl, aryl, and heteroaryl groups, as defined herein, are, in certain embodiments, optionally substituted. In general, the term “substituted” means that at least one hydrogen present on a group is replaced with a substituent, e.g., a substituent which upon substitution results in a stable compound. For purposes of this invention, heteroatoms such as nitrogen may have hydrogen substituents and/or any suitable substituent as described herein which satisfy the valencies of the heteroatoms and results in the formation of a stable moiety.

Contemplated aliphatic (alkyl, alkenyl, alkynyl, and carbocyclyl), heteroaliphatic (heteroalkyl, heteroalkenyl, heteroalkynyl, and heterocyclyl), aryl, and heteroaryl substituents are selected from the group consisting of halogen, —CN, —NO₂, —N₃, —SO₂H, —SO₃H, —OH, —OFC^{aa}, —ON(R^{bb})₂, —N(R^{bb})₂, —N(OR^{cc})R^{bb}, —SH, —SR^{aa}, —C(═O)R^{aa}, —CO₂H, —CHO, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═O)NR^{bb}SO₂R^{aa}, —NR^{bb}SO₂R^{aa}, —SO₂N(R^{bb})₂, —SO₂R^{aa}, C₁₋₁₀ alkyl, C₂₋₁₀ alkenyl, C₂₋₁₀ alkynyl, heteroC₁₋₁₀ alkyl, heteroC₂₋₁₀ alkenyl, heteroC₂₋₁₀alkynyl, C₃₋₁₀ carbocyclyl, 3-14 membered heterocyclyl, C₆₋₁₄ aryl, and 5-14 membered heteroaryl; or two geminal hydrogens (i.e., —CH₂)— on an alkyl, alkenyl, alkynyl, heteroalkyl, heteroalkenyl, heteroalkynyl, carbocyclyl, or heterocyclyl group are replaced with the group ═O, ═S, or =NR^{bb};

each instance of R^{aa} is, independently, selected from C₁₋₁₀ alkyl, C₂₋₁₀ alkenyl, C₂₋₁₀ alkynyl, heteroC₁₋₁₀ alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring;

each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —SO₂N(R^{cc})₂, —SO₂R^{cc}, C₁₋₁₀ alkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring; and

each instance of R^{cc} is, independently, selected from hydrogen, C₁₋₁₀ alkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring.

As used herein, the term “halo” or “halogen” refers to fluorine (fluoro, —F), chlorine (chloro, —Cl), bromine (bromo, —Br), or iodine (iodo, —I).

As used herein, the term “salt” refers to any and all salts, and which may include pharmaceutically acceptable salts as disclosed in Berge et al., describes pharmaceutically acceptable salts in detail in J. Pharmaceutical Sciences (1977) 66:1-19. Salts include salts of an amino group formed with inorganic acids such as hydrochloric acid, hydrobromic acid, phosphoric acid, sulfuric acid and perchloric acid, as well as organic acids such as acetic acid, oxalic acid, maleic acid, tartaric acid, citric acid, succinic acid or malonic acid. Salts further include salts of a carboxylic acid group (—CO2H) formed from alkali or alkaline earth metal bases to form sodium, lithium, potassium, calcium, or magnesium salts, and the like, or formed from ammonia or organic amino bases to form ammonium salts.

U.S. Provisional Application No. 62/594,255, filed Dec. 4, 2017, and entitled “Silver Recovery” is incorporated herein by reference in its entirety for all purposes. International Patent Publication No. WO 2015/095664, published on Jun. 25, 2015, and entitled “Method and Apparatus for Recovery of Noble Metals, Including Recovery of Noble Metals from Plated and/or Filled Scrap” is also incorporated herein by reference in its entirety for all purposes. International Patent Publication No. WO 2015/130965, published on Sep. 3, 2015, and entitled “Recovery of Gold and/or Silver from Scrap” is also incorporated herein by reference in its entirety for all purposes. International Patent Publication No. WO 2016/210051, published on Dec. 29, 2016, and entitled “Selective Removal of Noble Metals Using Acidic Fluids, Including Fluids Containing Nitrate Ions” is also incorporated herein by reference in its entirety for all purposes.

The following examples are intended to illustrate certain embodiments of the present invention, but do not exemplify the full scope of the invention.

### Example 1

5.0178 g of commercially available silver sulfate (certified ACS powder, by Fisher Sci.) was used in the experiment. This amount of powder contains 3.472 g of pure silver. The silver sulfate powder was placed in a beaker and covered with 20 ml of DI water. A solution of L-ascorbic acid (>=99.0%, heavy metals <=0.002%, by Fisher Sci.) was prepared, which contained 17.69 g of L-ascorbic acid per 100 ml of the solution. 1.4 times the stoichiometric value of L-ascorbic acid was added to the silver sulfate powder, which resulted in actual addition of 22.6 ml of the prepared L-ascorbic acid solution. The pH of the solution was 1.5. The solution was left on the stirring plate for 30 min, and the solid residue, which had an appearance of silver metal powder, was filtered out of the solution, rinsed with DI water and dried. The presence of silver in the supernatant solution was not detected. The purity of silver was analyzed by the XRF (SPECTROSCOUT XRF Analyser, by AMETEK), showing Ag=99.9±0.1%, Fe=0.08%, and all other metals below the detection limit. In order to verify the completeness of silver sulfate—silver metal transformation, the recovered silver powder was dissolved in a solution containing 10 ml of nitric acid (certified 68.0 to 70.0 w/w %, by Fisher Sci.) and 10 ml of DI water. Silver sulfate, if present, is insoluble in nitric acid, although silver metal is soluble. If any silver sulfate remained that was not converted to silver metal, it would not dissolve in nitric acid, and it would be visible as white powder remaining in the nitric acid solution after dissolution of the silver metal. In 6 min, all the silver metal dissolved in the nitric acid solution, and no traces of white powder of silver sulfate were detected.

### Example 2

The same experiment as in Example 1 was repeated, but instead of silver sulfate, silver acetate (by Fisher Sci.) was used. The silver salt was completely transformed to silver metal, and no traces of the residual non-transformed silver acetate were detected when the transformed silver powder was dissolved in the nitric acid.

### Example 3

60 ml of a leaching solution was prepared, which contained 48.75 ml of sulfuric acid (certified 95.0 to 98.0 w/w %, by Fisher Sci.), 9.75 ml of nitric acid (certified 68.0 to 70.0 w/w %, by Fisher Sci.), and 1.5 ml of methane-sulfonic acid (70% aqueous solution, by Alfa Aesar). A piece of silver metal weighting 26.9684 g was placed in a beaker containing the mixture of acids, and four pieces of copper metal with the total weight of 56.0204 g were added into the same beaker. The solution was heated to 55° C. and stirred for 2 hours. Subsequently, the silver and the copper nuggets were removed from the solution, rinsed, dried and weighed. The silver nugget lost 5.6716 g and the copper nuggets lost in total 0.2797 g.

In a separate beaker, 180 ml of DI water was stirred, and the solution containing dissolved silver and copper was added by drops to the water, with continuous stirring. When all the concentrated acid solution was added, the beaker was rinsed with DI water and the rinse water (15 ml) was added to the diluted leaching solution. The solution contained some dispersed solids, which were believed to be silver sulfate. Subsequently, 10M solution of sodium hydroxide (by Fisher Sci.) was added to the diluted leaching solution in order to raise its pH to 3; the resulting solution had a light blue col or. A sample of the solution was submitted for ICP analysis (performed with ICP-OES SPECTRO ARCOS EOP, by AMETEK). The concentration of silver in the solution was found to be 7510.12 mg/L, and the concentration of copper was found to be 625.99 mg/L. Considering the volume of the solution (416 ml), this meant that 3.1242 g of silver was dissolved in the solution, and the rest of the stripped silver (5.6716 g−3.1242 g=2.5474 g) was present in the form of a solid powder, which was believed to be silver sulfate. Also, the ICP analysis showed that 260.4 mg of copper were dissolved in the solution.

A solution of L-ascorbic acid (>=99.0%, heavy metals <=0.002%, by Fisher Sci.) was prepared separately, containing 18.65 g of L-ascorbic acid per 100 ml of solution. 1.4 stoichiometric amount of ascorbic acid (35 ml of the prepared solution) was added to the previously prepared slurry containing diluted leaching solution and solid silver sulfate powder. The mixture was left on the stirring plate overnight. Elemental silver metal powder could be observed on the bottom of the beaker, and the supernatant solution was clear and had light-blue col or the same as the solution had before the addition of the ascorbic acid. The sample of the liquid fraction was analyzed by ICP, showing the following concentrations: Ag=not detected (<0.2709 mg/L), Cu=604.92 mg/L. Considering the volume of this solution (402 ml), this meant 243.12 mg of copper remained dissolved in the solution after addition of the L-ascorbic acid. In other words, silver was completely removed from the solution by the addition of the L-ascorbic acid, but copper lost only 17.2 mg, which was 6.6% of its initial value. The silver powder was filtered out of the solution, rinsed with DI water and dried. Consequently, the silver metal powder was analyzed by an XRF (SPECTROSCOUT XRF Analyser, by AMETEK), showing:

Ag=99.9±0.1%,

Cu<0.007%.

The weight of the recovered silver powder was 5.370 g.

### Example 4

50 ml of a solution was generated by the electrolytic stripping of an Ag—CdO coating from a copper substrate; the solution contained a very small amount of solid silver sulfate salt powder. This solution was prepared by mixing 95% v/v of sulfuric acid (certified 95.0 to 98.0 w/w %, by Fisher Sci.) and 5% v/v of nitric acid (certified 68.0 to 70.0 w/w %, by Fisher Sci.). A piece of scrap copper, coated with silver-cadmium oxide, was used as an anode in the electrolytic cell, and a stainless steel bar was used as a cathode. When the electric current was on, the silver-cadmium oxide coating was dissolving in the solution, and as soon as all the coating dissolved, the electric current dropped to zero; the copper substrate was not visibly corroded. 50 ml of the leaching solution (containing dissolved silver, cadmium, and some copper) was added by small portions to 150 ml of DI water, with continuous vigorous agitation. 10M NaOH solution (by Fisher Sci.) was added to the resulting solution by drops, until the pH of the solution was 3. The volume of the resulting solution, including the rinse water, was 318 ml. A sample of this solution was analysed by ICP, showing the following concentrations: Ag=5169.31 mg/L, Cu=151.01 mg/L, Cd=271.34 mg/L. Considering the volume of the solution, this meant that 1.6438 g of silver, 48.02 mg of copper, and 86.29 mg of cadmium were dissolved in the solution.

A solution of L-ascorbic acid (>=99.0%, heavy metals <=0.002%, by Fisher Sci.) was prepared separately, containing 17.69 g of L-ascorbic acid per 100 ml of solution.

As the exact amount of silver dissolved in the solution was not known, it was assumed that the maximum concentration of silver in the initial concentrated acid solution could be 40 g/L. 50 ml of the solution could then contain a maximum of 2 g of silver. 1.4 times the stoichiometric amount of ascorbic acid (13 ml of the prepared solution) was added to the diluted leaching solution, and it was stirred for 1 hr 10 min. At the end of this period the solution was visibly separated into two phases—the elemental silver powder on the bottom and the clear liquid supernatant. The silver powder was filtered out of the solution and a sample of the solution was analyzed by ICP, showing: Ag—not detected (<16.860 mg/L), Cu=144.887 mg/L, Cd=256.04 mg/L. Considering the volume of the solution of 291 ml, 42.16 mg of copper and 74.51 mg of cadmium remained in the solution after addition of L-ascorbic acid. The silver powder was rinsed, dried and weighed. The mass of the recovered silver was 1.644 g. The XRF analysis of the recovered silver powder showed:

Ag=99.9±0.1%,

Cd<0.028%,

Cu<0.010%.

### Example 5

6.5 g of silver were dissolved into 40 ml of nitric acid, sulfuric acid, and methane sulfonic acid mixture (16% nitric acid, 81% sulfuric acid and 2.5% MSA) over 2 hours at 90° C. The result was a slurry of silver in dissolved in solution and silver in suspension (most likely as silver sulfate) with an approximate concentration of 162 g/L of silver (soluble and insoluble silver) The silver sulfate slurry was diluted with water to increase the volume to 310 ml.

The pH of the solution was increased with a NaOH solution to pH 1.5. This increased the final solution volume to 450 mL and the solution temperature to 66° C. The solution contained silver in a dissolved and solid form as a silver salt. 70 ml of a solution of erythorbic acid (d-isoascorbic acid) with a concentration of 100 g/L was added with mixing to the slurry to reduce the insoluble and soluble silver to silver metal. The slurry turned a grey col or indicative of the presence of finely divided silver metal. After 20 minutes the slurry was filtered and rinsed with water. The solids were dried and weighed. X-ray fluorescence analysis indicated the solids were metallic silver with a purity of 99.9%. The recovered weight of silver was 6.41 g indicating a silver recovery of 98.7%. While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of producing elemental silver from a silver-containing solution and/or suspension that contains solids comprising non-elemental silver, the method comprising:
combining the silver-containing solution and/or suspension with a reducing agent such that at least a portion of the solids comprising the non-elemental silver are exposed to the reducing agent to convert at least a portion of the non-elemental silver from the solids to elemental silver.

2. The method of claim 1, wherein the reducing agent comprises at least one of L-ascorbic acid, reductic acid, glucic acid, erythorbic acid, gluconic acid, gallic acid, glyoxylic acid, propionic acid, tannic acid, tartaric acid, citric acid, lactic acid, their respective salts, and combinations of two or more of these.

3. The method of claim 2, wherein the reducing agent comprises ascorbic acid.

4. The method of claim 2, wherein the reducing agent comprises erythorbic acid.

5. The method of any one of claims 1-4, wherein at least some of the solids comprise a silver salt.

6. The method of claim 5, wherein the silver salt comprises at least one of silver sulfate, silver acetate, and silver carbonate.

7. The method of any one of claims 1-6, wherein at least some of the solids comprise at least one of a silver oxide and a silver nitride.

8. The method of any one of claims 1-7, wherein the reducing agent transforms at least a portion (e.g., at least 10 wt %, at least 25 wt %, at least 50 wt %, at least 75 wt %, at least 90 wt %, at least 95 wt %, or at least 99 wt %) of the non-elemental silver in the solids to elemental silver without first solubilizing the non-elemental silver.

9. The method of any one of claims 1-8, wherein at least 50 wt %, at least 75 wt %, at least 90 wt %, at least 95 wt %, or at least 99 wt % of the non-elemental silver in the silver-containing solution and/or suspension is reduced to elemental silver.

10. A method of producing elemental silver from a silver-containing solution and/or suspension, comprising:
combining the silver-containing solution and/or suspension comprising silver in non-elemental form with a reducing agent, such that the reducing agent contacts the silver in non-elemental form, and the silver in non-elemental form is reduced to elemental silver.

11. The method of claim 10, wherein the reducing agent comprises at least one of L-ascorbic acid, reductic acid, glucic acid, erythorbic acid, gluconic acid, gallic acid, glyoxylic acid, propionic acid, tannic acid, tartaric acid, citric acid, lactic acid, their respective salts, and combinations of two or more of these.

12. The method of claim 11, wherein the reducing agent comprises ascorbic acid.

13. The method of claim 11, wherein the reducing agent comprises erythorbic acid.

14. The method of any one of claims 9-13, wherein at least a portion of the silver in non-elemental form is part of a solid.

15. The method of any one of claims 9-14, wherein at least a portion of the silver in non-elemental form is not part of a solubilized amine complex.

16. The method of any one of claims 9-15, wherein at least a portion of the silver in non-elemental form is non-complexed.

17. The method of any one of claims 9-16, wherein at least a portion of the silver in non-elemental form is part of a silver salt.

18. The method of claim 17, wherein the silver salt comprises at least one of silver sulfate, silver acetate, and silver carbonate.

19. The method of any one of claims 9-18, wherein at least a portion of the silver in non-elemental form is part of at least one of a silver oxide and a silver nitride.

20. The method of any one of claims 9-19, wherein at least a portion of the silver in non-elemental form is in the form of solubilized silver ions.

21. The method of any one of claims 9-20, wherein the reducing agent transforms at least a portion (e.g., at least 10 wt %, at least 25 wt %, at least 50 wt %, at least 75 wt %, at least 90 wt %, at least 95 wt %, or at least 99 wt %) of the silver in non-elemental form to elemental silver without first solubilizing the non-elemental silver.

22. The method of any one of claims 9-21, wherein at least 50 wt %, at least 75 wt %, at least 90 wt %, at least 95 wt %, or at least 99 wt % of the non-elemental silver in the silver-containing liquid is reduced to elemental silver.
